(19) United States
(12) Patent Application Publication
(10) Pub. No.: US 2026/0008368 A1
(43) Pub. Date: Jan. 8, 2026

(54) MODULAR AND SCALABLE ELECTRIC CHARGING TERMINAL FOR AN ELECTRIC VEHICLE

(71) Applicant: PAN BUSINESS & CONSULTING, BRIATEXTE (FR)

(72) Inventors: Paul-Antoine MALBERT, SAINT ORENS DE GAMEVILLE (FR); Nicolas VERMOREL, ALLAUCH (FR); Aurélien MICHEL-VIOUX, ROQUEVAIRE (FR)

(73) Assignee: PAN BUSINESS & CONSULTING, BRIATEXTE (FR)

(21) Appl. No.: 18/881,688

(22) PCT Filed: Jun. 26, 2023
(86) PCT No.: PCT/EP2023/067312

§ 371 Date: Jan. 6, 2025

(30) Foreign Application Priority Data
Jul. 5, 2022 (FR) FR2206826

(51) Int. Cl. B60L 53/31; B60L 53/16; B60L 53/30

(52) U.S. Cl. CPC B60L 53/31; B60L 53/16; B60L 53/305

(57) ABSTRACT

The invention relates to a modular and scalable electric charging terminal for an electric vehicle comprising a fixed chassis (30), a detachable electric power distribution unit (60) intended to be mounted on said fixed chassis (30) and means for detachably mounting the detachable distribution unit (60) on said fixed chassis (30).

### TECHNICAL FIELD OF THE INVENTION

The invention relates to a modular and scalable electric charging terminal for an electric vehicle.

### TECHNOLOGICAL BACKGROUND

The emergence of electric vehicles as a replacement for thermal vehicles involves reconsidering the energy supply infrastructures.

It is currently known that an electric vehicle is charged from an electric charging terminal. The number of available charging terminals is constantly increasing, thus improving regional coverage and the flexibility for using an electric vehicle.

With this being the case, the charging terminals that are currently in service have several disadvantages, including a total lack of modularity and scalability. In particular, in the event of a malfunction in the terminal, an evolution in the available technology or a legislative change, the charging terminal needs to be completely replaced, which involves mobilizing many operators.

Another disadvantage lies in the fact that it is impossible to modify the number of charging points on the terminal. If the area covered by the terminal experiences an increase in the number of electric vehicles, new terminals need to be installed, without being able to change the number of charging points on the terminal

Another disadvantage that arises from the two aforementioned disadvantages lies in the discontinuity of the service when a maintenance action, replacement of the hardware, modification of the number of charging points, etc., is required. In particular, the operation of the terminal needs to be interrupted, and operators need to be mobilized for fairly long periods in order to repair and/or replace the charging terminal.

Therefore, a requirement exists for the provision of a charging terminal that resolves at least some of the aforementioned disadvantages, in particular relative to the modification of the number of charging points. Indeed, it is currently common for a collective (such as a community or a village) to install an electric vehicle charging terminal in anticipation that this terminal will be used by a limited number of electric vehicles. As soon as the number of electric vehicles is about to increase, this same collective will have to install new terminals, without being able to modify the previously installed terminal. In other words, no solutions exist that would allow this collective to install a terminal it knows could be modified in terms of the number of charging points without any particular problems, should the need arise.

### AIMS OF THE INVENTION

The invention aims to provide a modular and scalable charging terminal for an electric vehicle.

In particular, the invention aims to provide, in at least one embodiment, such a charging terminal that limits service interruption in the event of the modification of the terminal.

In particular, the invention aims to provide, in at least one embodiment, a charging terminal that an operator can modify while limiting service interruption to a maximum of 5 minutes.

The invention also aims to provide, in at least one embodiment, such a charging terminal that allows the number of charging points to be modified without requiring any infrastructure work.

The invention also aims to provide, in at least one embodiment, a charging terminal that is easy to install, use, maintain and/or modify.

### DISCLOSURE OF THE INVENTION

To this end, the invention relates to a modular and scalable electric charging terminal for an electric vehicle comprising electric power and control equipment, characterized in that it comprises
a fixed chassis comprising:
   a base;
   means for anchoring the base to the ground;
   an outer shell secured to said base that defines a reception housing and an opening for accessing said reception housing;
   connection pins for connecting to an electric power distribution network;
a detachable electric power distribution unit conforming to the shape of said reception housing of said fixed chassis in order to be able to be housed therein, said detachable unit further comprising:
   a facade configured to be able to close off said opening, once the detachable unit is housed in said reception housing of said fixed chassis;
   a rigid frame supporting said facade;
   an electric terminal block supported by said frame and configured to be able to be electrically connected to said connection pins of said chassis;
   all said electric power and control equipment supported by said frame and electrically connected to said electric terminal block;
   at least one charging socket supported by said frame and extending into a through-opening provided in said facade, each charging socket being electrically connected to said electric power and control equipment and being configured to be able to be connected to an electric vehicle to be charged;
means for detachably mounting the detachable distribution unit on said fixed chassis.

The charging terminal according to the invention therefore has the particular feature of being formed by three main elements: the chassis intended to be anchored to the ground and electrically connected to the electric power distribution network, the detachable unit supporting the electric power and control equipment intended to be housed in the chassis, and the means for detachably mounting the unit on the chassis.

The detachable power distribution unit incorporates all the electric power and control equipment. In other words, all the equipment required for distributing electric power is incorporated in the detachable unit so that replacing a detachable unit with another unit allows the specifications of the charging terminal according to the invention to be modified.

Furthermore, the detachable unit comprises a facade that closes off the housing of the chassis. When extracting the detachable unit, only the outer shell and the connection pins for connecting to the electric distribution network remain, which are preferably arranged in the vicinity of the anchoring for the chassis.

When inserting the detachable unit, an operator must simply connect the electric terminal block of the detachable unit to the connection pins of the chassis in order to be able to set the charging terminal to the state for delivering an electric charging current.

The detachable unit also incorporates at least one charging socket supported by the frame. Each socket is electrically connected to the electric power and control equipment of the detachable unit and is configured to be able to be connected to an electric vehicle to be charged. For example, this electric socket can receive a charging cable, a first free end of which can be plugged into the charging socket and the other free end of which can be plugged into the electric vehicle. This configuration is particularly suitable for terminals powered with alternating current. According to another variant, particularly for terminals powered with direct current, the charging socket of the terminal is secured to a charging cable, the free end of which can be plugged into the electric vehicle.

Irrespective of the embodiment, it is easy to modify the number of charging points of the terminal by replacing the detachable unit with another unit comprising a different number of charging sockets. Therefore, the particular feature of the invention involves, on the one hand, splitting the chassis anchored to the ground and the power and distribution equipment and, on the other hand, grouping together all the power and distribution equipment within the same unit, which can be extracted as a single piece.

This separation between the chassis anchored to the ground and the power and distribution equipment supported by the detachable unit allows the terminal to be modified quickly and without any problems in the event of a regulatory change, of a software update, of a modification of the hardware, etc. To this end, the obsolete detachable unit simply needs to be replaced with a new unit complying with the new specificities in order to have an updated terminal.

The detachable unit can be inserted into the chassis as a single piece and can be extracted from the unit as a single piece. However, there is nothing preventing the unit as such from being formed by a plurality of elements assembled together before being inserted into the chassis, for example, by interlocking, clipping, screwing or any equivalent means.

The mechanical connection between the detachable unit and the chassis is achieved by detachable mounting means, described hereafter.

Advantageously and according to the invention, the terminal further comprises means for locking the detachable unit on said fixed chassis that are configured to be able to prevent, in a locked position, any extraction of said detachable unit from said chassis, and to allow, in an unlocked position, the extraction of said detachable unit from said fixed chassis.

The charging terminal according to this advantageous variant makes it possible to prevent any extraction of the detachable unit from said chassis when the locking means are in the locked position. This notably makes it possible to ensure that only an authorized operator can extract the detachable unit from the chassis, for example, by making the transition of the locking means from the locked position to the unlocked position contingent upon a specific action of the operator and/or upon the use of a specific tool by the operator.

Advantageously and according to this variant, said locking means comprise mechanical locking means coupled to electronic locking means.

A charging terminal according to this variant allows, for example, the locking means to transition from the locked position to the unlocked position in the event of a loss of voltage or by means of a remote control or by reading a badge of an authorized operator. Furthermore, this allows the charging terminal to be secured by making the unlocking of the terminal contingent upon a dual action on the mechanical means and on the electronic means.

The mechanical locking means are formed, for example, by a mechanical lock with a cam and a universal key arranged at the rear of the chassis, with the cam thereof being able to be moved by the action of the universal key in order to be housed in a striker supported by the detachable unit.

Advantageously and according to the invention, said means for detachably mounting said detachable unit on said fixed chassis comprise a shaft mounted to freely pivot on said detachable unit and at least one fixing screw extending through a bore formed in said shaft perpendicular to the pivot shaft, said screw being engaged with said base of said fixed chassis, such that said detachable unit can pivot about said pivot shaft relative to said chassis, between an open position, in which the detachable unit can be detached from said chassis by extracting each fastening screw, and a closed position, in which the unit is fully housed in said reception housing of said chassis.

According to this advantageous variant, a pivot shaft is secured to said fixed chassis by at least one screw (preferably two screws) passing through the shaft and engaged with the base of the chassis. Furthermore, the shaft is freely mounted on said detachable unit so that the detachable unit can pivot relative to the shaft. Since this shaft is fixed relative to the base, the detachable unit can pivot relative to the chassis. In other words, the combination of the shaft which pivots freely relative to the detachable unit and of the screws for fastening the shaft on the base forms a detachable hinge for pivoting the detachable unit on said chassis.

The extraction time of the detachable unit therefore corresponds to the time required for unscrewing the screws and the time required for separating the electric cables that connect the terminal block of the detachable unit to the connection pins of the chassis. Thus, the detachable unit can be extracted in less than 5 minutes of intervention time.

According to this advantageous variant, said shaft further comprises circlips arranged at each end of the shaft for blocking any translation movements of the detachable unit along the pivot shaft.

Advantageously and according to the invention, the terminal further comprises at least one retention cable, preferably two cables, extending between the outer shell and said rigid frame and configured to keep the detachable unit suspended when said detachable unit is pivoted about the pivot shaft and tilted to the open position.

According to this variant, the detachable unit is kept suspended when it is pivoted to the open position. Thus, an operator can proceed with the operations of unscrewing the screws of the hinge, while holding the unit via the retention cables. Once unscrewing is complete, the operator can separate the retention cable from the detachable unit and extract the unit. These cables can each include, for example, an end provided with an eyelet configured to engage in a lug supported by the outer shell and/or the detachable unit.

Advantageously and according to the invention, said electric power and control equipment supported by said rigid frame of said detachable unit comprises at least one electronic control board, called main board, of said terminal, an electronic board of a human-machine interface supported by said facade, at least one circuit breaker, at least one transformer, at least one differential switch and at least one electronic meter.

Advantageously and according to the invention, the terminal further comprises a data terminal block supported by said facade and configured to be able to be connected to a computer network, for example, by means of a terminal block secured to said fixed chassis.

According to this advantageous variant, the terminal can be connected to a computer network of the Internet network type so as to receive control instructions or software updates and to transmit operating information (consumption, charging, etc.).

Advantageously and according to the invention, at least one charging socket, preferably each charging socket, is provided with a protective flap pivotably mounted on said facade.

The charging terminal according to this variant allows the charging sockets to be protected from bad weather and direct exposure of the charging sockets to be avoided.

Advantageously and according to the invention, the terminal further comprises a handle for carrying said detachable unit mounted on said rigid frame and extending into said reception housing, once the detachable unit is mounted on said chassis.

This handle facilitates the transportation of the detachable unit by an operator. This carrying handle is directly formed, for example, by a portion of the frame of the charging terminal that is configured so that an operator can pass their hand through it.

The invention also relates to a charging terminal that in combination is characterized by all or some of the features mentioned above or hereafter.

### LIST OF FIGURES

Further aims, features and advantages of the invention will become apparent upon reading the following description, which is provided solely by way of a non-limiting example and which refers to the appended figures, in which:

FIG. 1 is a schematic view of a charging terminal according to the invention with an electric vehicle connected thereto;

FIG. 2 is a schematic perspective view of a charging terminal according to one embodiment of the invention that has a single charging point;

FIG. 3 is a schematic perspective view of a charging terminal according to one embodiment of the invention that has three charging points;

FIG. 4 is a schematic view of a charging terminal according to one embodiment of the invention where the detachable unit is tilted to the open position with a view to the extraction thereof;

FIG. 5 is a schematic rear perspective view of a detachable unit of a charging terminal according to one embodiment of the invention where the electric equipment is not shown;

FIG. 6 is a schematic front perspective view of the detachable unit of FIG. 5;

FIG. 7 is a schematic front view of the detachable unit of FIGS. 5 and 6;

FIG. 8 is a schematic side view of the detachable unit of FIGS. 5, 6 and 7 also showing the electric equipment;

FIG. 9 is a schematic cross-section view of the means for detachably mounting the detachable unit on the chassis of a charging terminal according to one embodiment of the invention.

### DETAILED DESCRIPTION OF AN EMBODIMENT OF THE INVENTION

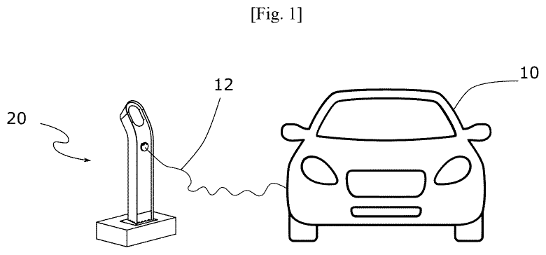

In the figures, the scales and the proportions are not strictly followed for the sake of illustration and clarity. Throughout the following detailed description with reference to the figures, unless otherwise indicated, each element of the charging terminal is described as it is arranged when the charging terminal is anchored to the ground. This configuration is notably shown in FIGS. 1, 2 and 3. Furthermore, identical, similar or comparable elements are designated using the same reference signs throughout all the figures.

FIG. 1 shows an electric vehicle 10 connected to a charging terminal 20 by means of an electric cable 12.

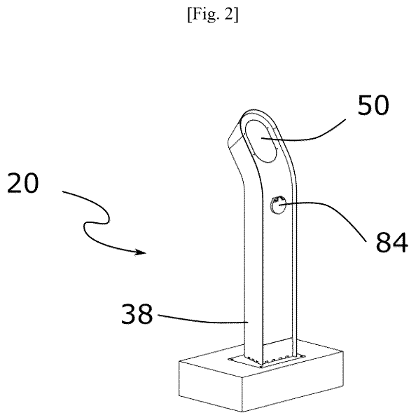

The charging terminal 20 is described in greater detail with reference to FIGS. 2 to 9.

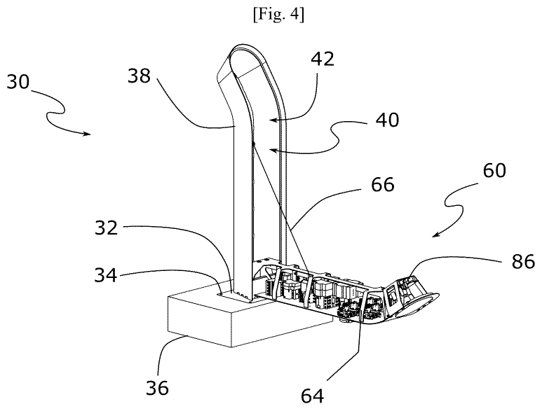

This charging terminal mainly comprises a chassis 30 and a detachable unit 60 as shown in FIG. 4.

The fixed chassis 30 comprises a base 32, studs 34 for anchoring the base to the ground, which is formed by a concrete base 36, for example.

The chassis also comprises an outer shell 38, which is formed by sheet metal, for example, and which forms a reception housing 40 for the detachable unit 60. This outer shell 38 is secured to the base 32, for example, by means of a plate screwed onto the base. The reception housing 40 is accessible through an opening 42 intended to be closed off by the facade of the detachable unit described hereafter.

Finally, the chassis 30 comprises connection pins for connecting to an electric power distribution network (not shown in the figures).

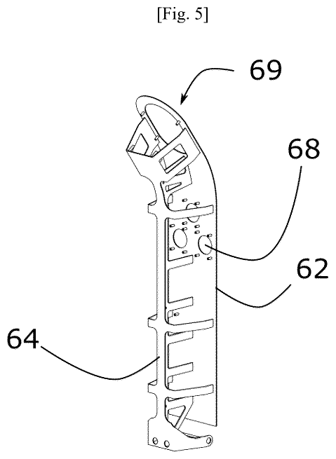

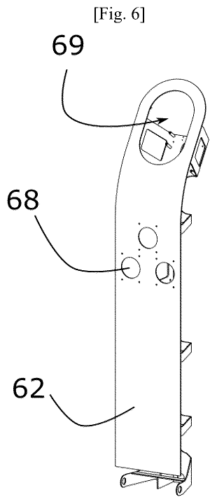

The detachable unit 60 comprises, as shown in FIGS. 5 and 6, a facade 62 intended to close off the opening 42 of the reception housing 40 of the chassis, once the unit is housed in the chassis.

This detachable unit 60 further comprises a rigid frame 64 that supports the facade 62 and the electric power and control equipment.

FIGS. 5 and 6 illustrate the rigid frame 64 of the detachable unit and the facade 62, without the electric power and control equipment. These two figures also show the openings 68 provided in the facade 62 that are intended to allow passage of the charging sockets 84 that are intended to receive cables 12 for charging an electric vehicle 10. These figures also show an opening 69 that is intended to receive a human-machine interface module 50 configured to control the charging terminal. This human-machine interface module 50 can be of any known type. It comprises an interface that interacts with an electronic board, itself connected to the various items of electric power and control equipment to ensure the charging of the electric vehicle connected to the charging terminal by means of the charging cable.

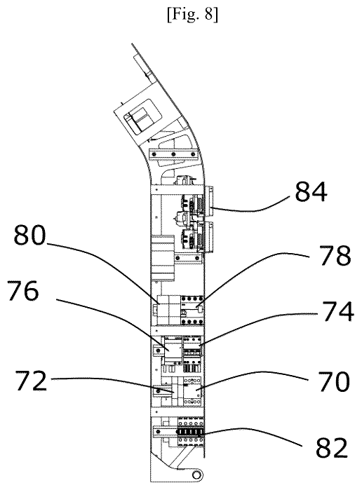

FIG. 8 illustrates the unit provided with the electric power and control equipment.

This electric power and control equipment comprises, for example, a contactor 70, a meter 72, a circuit breaker 74, a transformer 76, a differential switch 78 and a differential circuit breaker 80. Of course, other electric power and control equipment can be provided as a function of the targeted electric features of the charging terminal. A person skilled in the art will be able to easily determine the type of electric power and control equipment required to form an electric charging terminal. The heart of the invention does not lie in the choice of electric power and control equipment, but in the technical means for easily housing the detachable unit and extracting the detachable unit from the chassis so as to form a scalable and modular charging terminal.

The rigid frame 64 that supports the electric equipment can include, for example, a DIN rail for facilitating the mounting of the equipment.

The rigid frame 64 also supports an electric terminal block 82 intended to connect the detachable unit to the connectors of the chassis.

Finally, the detachable unit comprises electric charging sockets 84. The number of charging sockets depends on the targeted number of charging points. Each socket is electrically connected to the electric power and control equipment and is configured to be able to be connected to an electric vehicle to be charged, for example, by means of a charging cable.

A charging terminal according to the invention further comprises means for detachably mounting the detachable unit 60 on the fixed chassis 30.

According to the embodiment of the figures, these detachable mounting means are formed by a shaft 90 that has two through-tappings and a screw-nut system 92 housed in the tappings in order to engage on the ground, so as to be able to fix the shaft 90 relative to the ground and to the chassis.

This shaft 90 is also freely mounted on the detachable unit 60 so that the detachable unit can pivot about the shaft 90, when the shaft is fixed to the ground by the screw-nut systems 92.

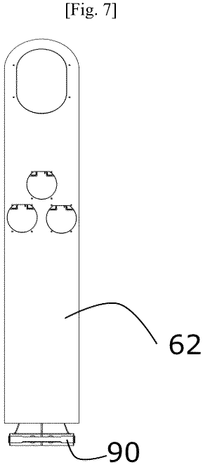

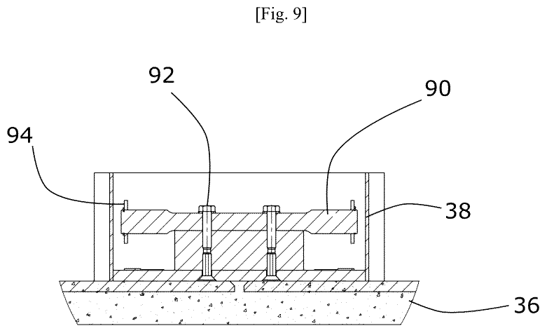

This pivot shaft 90 is notably shown in FIGS. 7 and 9.

Thus, mounting the detachable unit 60 on the chassis 30 consists of inserting the screws 92 into the tappings of the shaft 90 and engaging the screws in the ground, then pivoting the detachable unit 60 about the shaft so that it comes to be housed in the reception housing 40. Before pivoting the detachable unit, an operator electrically connects the terminal block of the detachable unit to the connection pins of the chassis.

The charging terminal according to this embodiment thus allows the detachable unit to be quickly and simply mounted on the chassis and housed in the reception housing, by simply pivoting the unit about the pivot shaft. This operation can be carried out by a single operator in less than 5 minutes.

According to other embodiments not shown in the figures, other detachable mounting means can be provided instead of the pivot shaft, such as, for example, means for clipping the detachable unit into the outer shell of the chassis, or means for screwing the detachable unit onto the outer shell.

As shown in FIG. 4, the charging terminal according to this embodiment further comprises a retention cable 66 that extends between the outer shell 38 of the chassis 60 and the rigid frame 64 of the detachable unit 60. This retention cable 66 is, for example, a wire rope intended to keep the detachable unit 60 suspended when said unit is in the open position (as shown in FIG. 4). According to another variant, the terminal can comprise two cables, each extending between the outer shell and the detachable unit in order to balance the suspension of the unit on either side of the detachable unit.

In order to secure the housing for the unit in the chassis, the terminal advantageously comprises means for locking the detachable unit on the fixed chassis.

These means are formed, for example, by an electromagnetic locking finger 86 configured to engage with the outer shell 38. In addition to this electromagnetic locking, the locking means can comprise a mechanical lock with a cam and a universal key arranged at the rear of the chassis (not shown in the figures), with the cam thereof being able to be moved by the action of the universal key in order to be housed in a striker supported by the detachable unit.

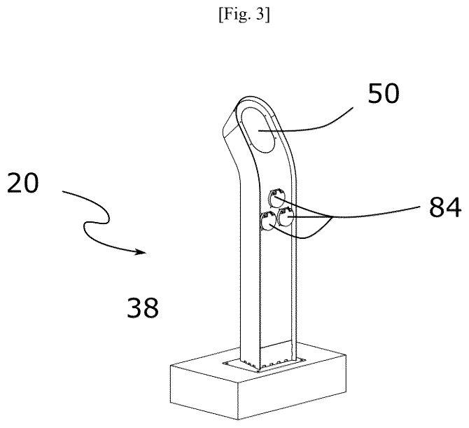

The charging terminal according to the invention allows its specific features, such as, for example, its number of charging points, to be quickly modified. For example, in order for the charging terminal to transition from having one charging point to having three charging points, the detachable unit with one charging point simply needs to be removed from its chassis and a detachable unit with three charging points needs to be inserted therein. These detachable units can be designed in the workshop and exchanged according to requirements without requiring any intervention on the chassis of the terminal. The detachable unit thus forms a “plug & play” type device. By way of an example, FIG. 2 illustrates the terminal with a single charging point and FIG. 3 illustrates the terminal with three charging points.

The detachable unit 60 is preferably made in such a way that its weight does not exceed 15 kg, in order to be able to be extracted from the chassis and carried by a single operator. To this end, the rigid frame and the facade are preferably made of 3 mm thick sheet metal. Of course, there is nothing preventing the use of other types of materials for forming the detachable unit depending on the requirements and the local constraints.

Throughout the figures, the detachable unit is depicted as a device in a single piece. With this being the case, according to other embodiments, the detachable unit can be formed by several distinct elements that can be secured to one another (for example, by interlocking) before being inserted into the reception housing of the chassis.

1. A modular and scalable electric charging terminal for an electric vehicle comprising electric power and control equipment, the terminal comprising characterized in that it comprises:
a fixed chassis comprising:
a base;
means for anchoring the base to the ground;
an outer shell secured to said base that defines a reception housing and an opening for accessing said reception housing;
connection pins for connecting to an electric power distribution network;
a detachable electric power distribution unit conformed to said reception housing of said fixed chassis in order to be able to be housed therein, said detachable unit further comprising:
a facade configured to be able to close off said opening, once the detachable unit is housed in said reception housing of said fixed chassis;
a rigid frame supporting said facade;
an electric terminal block supported by said frame and configured to be able to be electrically connected to said connection pins of said chassis;
all said electric power and control equipment supported by said frame and electrically connected to said electric terminal block;
at least one charging socket supported by said frame and extending into a through-opening provided in said facade, each charging socket being electrically connected to said electric power and control equipment and being configured to be able to be connected to an electric vehicle to be charged;
means for detachably mounting the detachable distribution unit on said fixed chassis.

2. The charging terminal as claimed in claim 1, further comprising means for locking the detachable unit on said fixed chassis that are configured to be able to prevent, in a locked position, any extraction of said detachable unit from said chassis, and to allow, in an unlocked position, the extraction of said detachable unit from said fixed chassis.

3. The charging terminal as claimed in claim 2, wherein said locking means comprises mechanical locking means coupled to electronic locking means.

4. The charging terminal as claimed in claim 1, wherein said means for detachably mounting said detachable unit on said fixed chassis comprise a shaft mounted to freely pivot on said detachable unit and at least one fixing screw extending through a bore formed in said shaft perpendicular to the pivot shaft, said screw being engaged with said base of said fixed chassis, such that said detachable unit can pivot about said pivot shaft relative to said chassis, between an open position, in which the detachable unit can be detached from said chassis by extracting each fastening screw, and a closed position, in which the unit is fully housed in said reception housing of said chassis.

5. The charging terminal as claimed in claim 4, further comprising at least one retention cable, preferably two cables, extending between the outer shell and said rigid frame and configured to keep the detachable unit suspended when said detachable unit is pivoted about the pivot shaft and tilted to the open position.

6. The charging terminal as claimed in claim 1, wherein said electric power and control equipment supported by said rigid frame of said detachable unit comprises at least one electronic control board, called main board, of said terminal, an electronic board of a human-machine interface supported by said facade, at least one circuit breaker, at least one transformer, at least one differential switch and at least one electronic meter.

7. The charging terminal as claimed in claim 1, further comprising a data terminal block supported by said facade and configured to be able to be connected to a computer network.

8. The charging terminal as claimed in claim 1, wherein at least one charging socket, preferably each charging socket, is provided with a protective flap pivotably mounted on said facade.

9. The charging terminal as claimed in claim 1, further comprising a handle for carrying said detachable unit mounted on said rigid frame and extending into said reception housing, once the detachable unit is mounted on said chassis.
